(19) United States
(12) Patent Application Publication
(10) Pub. No.: US 2025/0041915 A1
(43) Pub. Date: Feb. 6, 2025

(54) FAUCET CLEANING DEVICE AND METHOD OF USE

(71) Applicant: Jessica Lamb, Twinsburg, OH (US)

(72) Inventor: Jessica Lamb, Twinsburg, OH (US)

(21) Appl. No.: 18/787,195

(22) Filed: Jul. 29, 2024

Related U.S. Application Data
(60) Provisional application No. 63/529,466, filed on Jul. 28, 2023.

(51) Int. Cl. B08B 9/02

(52) U.S. Cl. CPC B08B 9/021; B08B 2209/02; E03C 2201/70

(57) ABSTRACT

A faucet cleaning device has a bag having an inside area, a sponge, a cleaning agent and an adhesive. The sponge is located inside the bag and a cleaning agent is located inside the bag. The adhesive is attached to the bag. A faucet head is placed into the inside of the bag. The faucet cleaning device is attached to the faucet with the adhesive filling the bag with water from the faucet waiting a duration of time.

### CLAIM OF PRIORITY

This application claims priority from provisional patent application Ser. No. 63/529,466 filed on Jul. 28, 2023, the entirety of which is hereby incorporated by reference.

### BACKGROUND OF THE DISCLOSURE

The present disclosure relates to devices and methods for a faucet cleaning device. It finds particular application in cleaning and soaking of the faucet head and will be described with particular reference thereto. However, it is to be appreciated that the present exemplary embodiment is also amenable to other like applications.

Nearly all faucets will experience material or scale buildup in and around the faucet head as a result of minerals and particulates in the water being dispensed from said faucet. Such material build up may lead to flow disruptions and large deposits of material resulting in the water flowing from the faucet. In order to reduce the likelihood of these issues it is necessary to occasionally clean the faucet and remove material buildup.

A convenient and mess free way of cleaning a faucet is desired in order to minimize and control material buildup on the faucet.

Accordingly, there is a need for a faucet cleaning device which overcomes the above-mentioned deficiencies and others while providing better overall results.

### BRIEF DESCRIPTION OF THE DISCLOSURE

Disclosed herein are faucet cleaning devices and methods for using the devices.

Disclosed in various embodiments are faucet cleaning devices that allow for a faucet to be soaked in a cleaning solution in order to remove potential material buildup. In particular embodiments a cleaning agent is provided to create a cleaning solution with water from the faucet to be cleaned.

In accordance with a preferred embodiment of the disclosure, a faucet cleaning device has a bag having an inside portion, a sponge, a cleaning agent, and an adhesive.

In accordance with another embodiment of the disclosure, method for cleaning a faucet includes the steps of providing a faucet cleaning device, the faucet cleaning device having a bag having an inside area, a sponge located inside the bag, a cleaning agent located inside the bag, and an adhesive attached to the bag; and placing a faucet head into the inside of the bag; and attaching the faucet cleaning device to the faucet with the adhesive, and filling the bag with water from the faucet waiting a duration of time.

In some embodiments the cleaning agent may be citric acid powder. In a preferred embodiment the sponge may be dehydrated and then be rehydrated during the cleaning process. Any embodiment may include the adhesive being double sided tape or another suitable adhesive.

Disclosed in other embodiments are methods which utilize the faucet cleaning device described herein.

Still other aspects of the disclosure will become apparent upon a reading and understanding of the following detailed description.

### BRIEF DESCRIPTION OF THE DRAWINGS

FIG. 1 is a perspective view of a faucet cleaning device in accordance with an aspect of the disclosure.

FIG. 2 is a top perspective view of a faucet cleaning device attached to a faucet during cleaning.

FIG. 3 is a bottom perspective view of a faucet cleaning device attached to a faucet during cleaning.

FIG. 4 is a front elevated view of a faucet cleaning device of FIGURE

FIG. 5 is a side elevated view of a faucet cleaning device of FIG. 1

### DETAILED DESCRIPTION OF THE DISCLOSURE

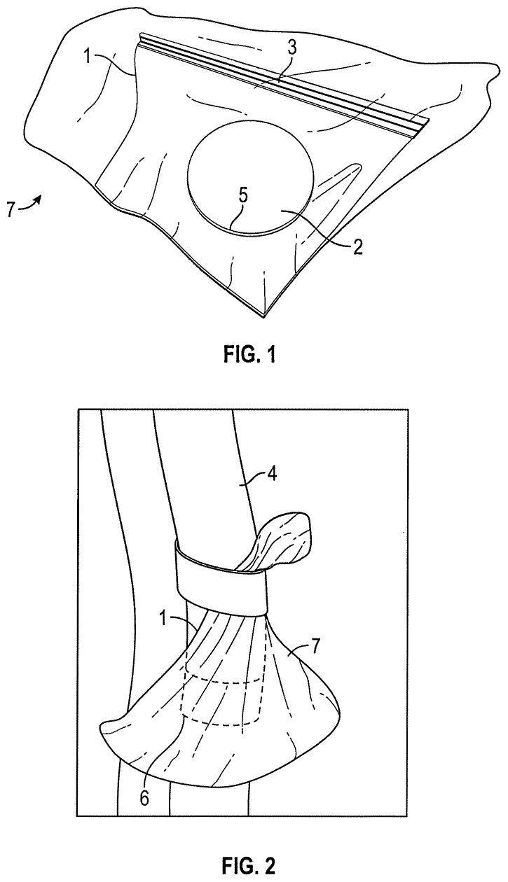

With reference to FIG. 1, a faucet cleaning device 7 in accordance with the present disclosure is shown. The faucet cleaning device 7 includes a bag 1, a sponge 2, an adhesive 3, and a cleaning agent 5. The sponge 2 and cleaning agent 5 are located inside the bag 1.

In some embodiments the cleaning agent 5 may be citric acid powder. In a preferred embodiment the sponge 2 may be dehydrated and then be rehydrated during the cleaning process. Any embodiment may include the adhesive 3 being double sided tape or another suitable adhesive.

FIG. 2 shows the faucet cleaning device 7 in use on a faucet 4. The bag 1 envelopes and enclosed the faucet 4. Water placed in the bag 1 mixes with the cleaning agent 5 to create a cleaning solution 6.

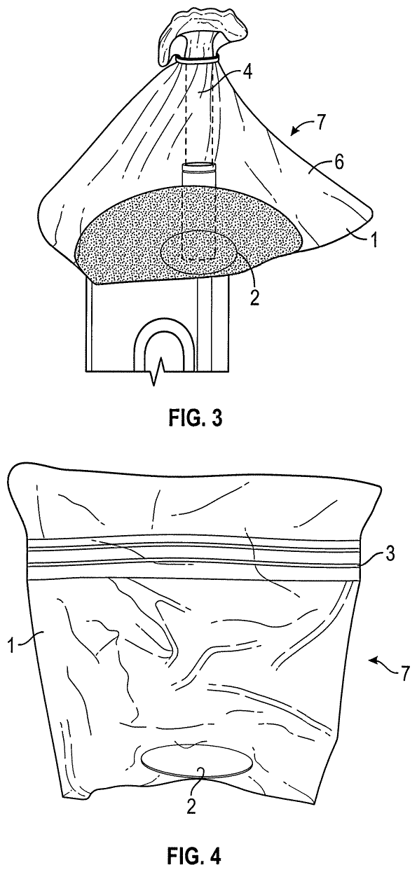

FIG. 3 shows a different angle of the faucet cleaning device 7 in use on a faucet 4. The bag 1 can again be seen surrounding the faucet 4 with the sponge 2 pressed against the faucet 4. In the preferred embodiment the sponge 2 is a dehydrated sponge that becomes rehydrated with cleaning solution 6. The cleaning solution 6 soaked sponge 2 is pressed against the faucet 4 to facilitate the cleaning of the faucet.

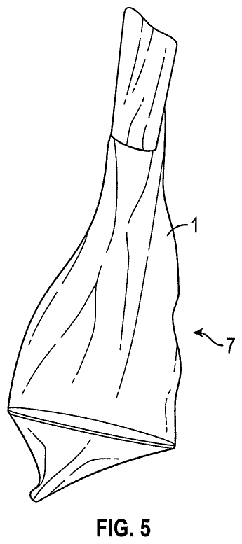

FIG. 4 shows a first side view of the faucet cleaning device 7. The bag 1 can be seen with the sponge 2 inside the bag 1 and the adhesive 3 attached to the bag. In some embodiments an adhesive 3 may be used to attach the sponge 2 directly to the bag 1.

FIG. 5 shows a second side view of the faucet cleaning device 7. This view illustrates that the use of a bag 1 may allow the faucet cleaning device 7 to be easily compacted for shipment and storage.

The exemplary embodiment has been disabled with reference to the preferred embodiments. Obviously, modifications and alterations will occur to others upon a reading and understanding of the detailed description. It is intended that the exemplary embodiment be construed as including all such modifications and alterations in so far as they come within the scope of the disclosure.

1. A faucet cleaning device comprising:
a bag having an inside portion;
a sponge;
a cleaning agent; and
an adhesive.

2. The faucet cleaning device of claim 1, wherein the sponge and cleaning agent are located in the bag inside portion.

3. The faucet cleaning device of claim 2, wherein the sponge is dehydrated.

4. The faucet cleaning device of claim 2, wherein the cleaning agent is citric acid powder.

5. The faucet cleaning device of claim 2, wherein the adhesive is double sided tape.

6. The faucet cleaning device of claim 5, wherein the double sided tape adheres the bag to an associated faucet for the duration of cleaning.

7. The faucet cleaning device of claim 2, wherein the sponge may be attached to the bag with an adhesive.

8. The faucet cleaning device of claim 7, wherein the adhesive is double sided tape.

9. A method for cleaning a faucet, the method comprising the steps of:
providing a faucet cleaning device, the faucet cleaning device comprising a bag having an inside portion, a sponge located inside the bag inside portion, a cleaning agent located inside the bag inside portion, and an adhesive attached to the bag;
placing a faucet head into the bag inside portion;
attaching the faucet cleaning device to the associated faucet with the adhesive;
filling the bag with water from the faucet;
waiting a duration of time;
removing the faucet cleaning device from the faucet.

10. The method of claim 9, wherein the sponge is dehydrated.

11. The method of claim 9, wherein the cleaning agent is citric acid powder.

12. The method of claim 9, wherein the adhesive is double sided tape.

13. The method of claim 9, wherein the sponge may be attached to the bag with an adhesive.

14. The method of claim 13, wherein the adhesive is double sided tape.
